(19) United States
(12) Patent Application Publication
(10) Pub. No.: US 2014/0020105 A1
(43) Pub. Date: Jan. 16, 2014

(54) Distributing Software Images with Mixed Licensing

(71) Applicants: William Nix, Austin, TX (US); Clint H. O'Connor, Austin, TX (US); Michael Haze, Round Rock, TX (US); Yuan-Chang Lo, Austin, TX (US)

(72) Inventors: William Nix, Austin, TX (US); Clint H. O'Connor, Austin, TX (US); Michael Haze, Round Rock, TX (US); Yuan-Chang Lo, Austin, TX (US)

(21) Appl. No.: 13/545,094

(22) Filed: Jul. 10, 2012

(51) Int. Cl. G06F 21/24

(52) U.S. Cl. 726/26

(57) ABSTRACT

A system, method, and computer-readable medium are disclosed for managing the licensing of digital assets associated with a system image. A system image is processed to identify digital asset identification information, which in turn is processed to determine whether its associated digital asset is available for licensing from a system manufacturer. If the digital asset could not be identified, or if it is unavailable for licensing from the system manufacturer, then it is marked as “custom.” Otherwise, it is marked as “available” and presented to a system purchaser. Any digital assets that the system purchaser elects to license are marked as “license” and all other digital assets are marked as “custom.” Digital assets marked as “license” are then licensed from the system manufacturer. Both licensed and “custom” digital assets are installed and their corresponding licenses are applied to the system image, which in turn is applied to the target system.

### BACKGROUND OF THE INVENTION

1. Field of the Invention

The present invention relates to the management of information handling systems. More specifically, embodiments of the invention provide a system, method, and computer-readable medium for managing the licensing of digital assets associated with a system image.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In recent years, it has become common for manufacturers to offer purchasers the ability to order a system custom-configured to their specification. These custom-configured systems, which are often ordered on-line, allow the purchaser to select the OS of their choice along with a selection of software and other digital assets to meet their individual needs. In some cases, the manufacturer may preinstall the OS and the selected digital assets on the system prior to delivery. In addition, the system may be further personalized (e.g., desktop themes and colors, etc.) as a service to the customer. Such customizations and personalizations may be limited only by the customer's patience and willingness to define or describe their ideal system.

One known approach to such personalization is Custom Factory Integration (CFI). Such CFI processes typically include a pre-sale consultation, in which the purchaser informs the vendor of specific needs and preferences, and the vendor offers various options. The product is in effect built to order, which typically includes the vendor preinstalling software and other digital assets on the system through the application of a system image. The system is then tested at the factory prior to delivery to the customer.

In general, CFI can save time in the manufacturing cycle for the vendor, minimize the total cost of ownership (TCO) for the buyer, streamline the installation process, and minimize compatibility problems in environments where multiple operating platforms are used. However, the customer is typically responsible for managing the licenses for all digital assets contained in a CFI system image, which can offset the advantages CFI offers. Furthermore, the system image may contain proprietary digital assets that the vendor is not authorized to license. As a result, the system purchaser may be required to subsequently apply certain of these digital assets to the system image, which can be tedious, time consuming, and error-prone. In view of the foregoing, there is a need for a more effective approach to managing the licensing of digital assets associated with a system image.

### SUMMARY OF THE INVENTION

A system, method, and computer-readable medium are disclosed for managing the licensing of digital assets associated with a system image. In various embodiments, a system purchaser elects to have a predetermined system image comprising one or more digital assets be applied to a target system. In these and other embodiments, the system image is processed to identify digital asset title identification information, which in turn is used populate a digital asset profile. The digital asset title information is then processed to determine whether its associated digital asset is available for licensing from the system manufacturer. If so, then its digital asset title is marked as “available” in the digital asset profile. However, if the digital asset could not be identified from its digital asset title information, or if it is unavailable for licensing from the system manufacturer, then it is marked as “custom” in the digital asset profile.

Digital asset titles that are marked as “available” for licensing from the system manufacturer are then presented to the system purchaser. Any digital asset titles that the system purchaser elects to license from the system manufacturer are in turn marked as “license” in the digital asset profile. All other digital asset titles are marked as “custom” in the digital asset profile. The digital assets corresponding to digital asset titles marked as “custom” in the digital asset profile are then stored in a “custom” digital assets repository. The digital assets corresponding to digital asset titles marked as “license” in the digital asset profile are then licensed from the system manufacturer.

If the system purchaser has elected to license one or more digital assets from the system manufacturer, then digital asset entitlement operations are performed, which binds the digital assets and their respective digital assets entitlement data to a unique identifier of the target system. Any licensed and “custom” digital assets are then installed, and their corresponding licenses are applied to the system image, which in turn is then applied to the target system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of the performance of digital asset license management operations;

FIGS. 3a-b are a generalized flow chart of the performance of digital asset entitlement operations;

FIGS. 4a-b are a generalized flow chart of the performance of system image creation operations; and

FIG. 5 is a generalized flow chart of the performance of system image replication operations.

### DETAILED DESCRIPTION

A system, method, and computer-readable medium are disclosed for managing the licensing of digital assets associated with a system image. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

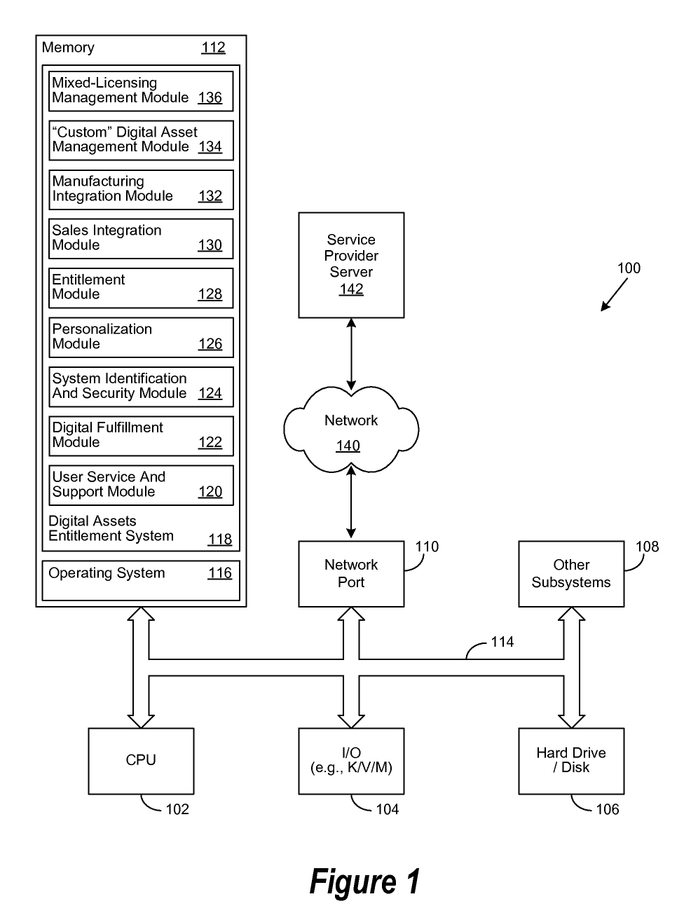

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a digital asset entitlement system 118. In these and other embodiments, the digital asset entitlement system 118 may likewise comprise a user service and support module 120, a digital fulfillment module 122, a system identification and security module 124, a personalization module, an entitlement module 128, a sales integration module, a manufacturing integration module 132, a mixed-licensing management module 134, and a “custom” digital asset management module 136. In one embodiment, the information handling system 100 is able to download the digital asset entitlement system 118 from the service provider server 142. In another embodiment, the digitals asset entitlement system 118 is provided as a service from the service provider server 142.

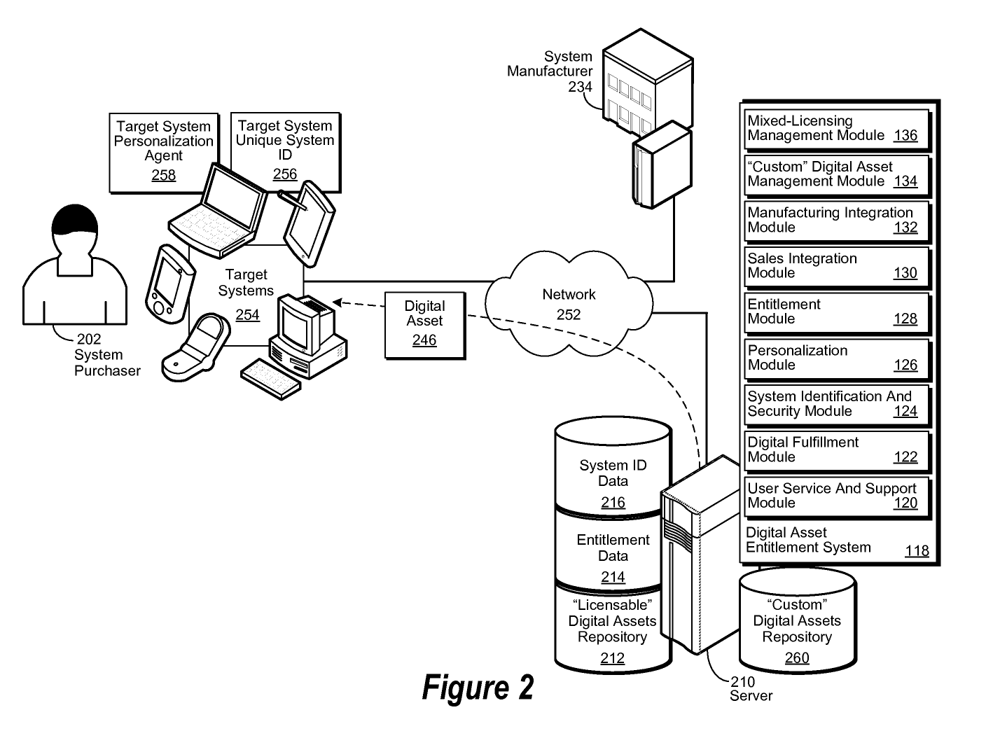

FIG. 2 is a simplified block diagram of the performance of digital asset license management operations. In various embodiments, the management of licensing of digital assets associated with a system image is facilitated by processing the system image to determine identifying information related to digital assets it contains. In these and other embodiments, the identifying information may comprise its title (e.g., Microsoft® Word® 2010, Professional Edition), its Stock Keeping Unit (SKU), language, and licensing method. Skilled practitioners of the art will realize that the system image may contain other relevant digital asset identification information and that the foregoing is not intended to limit the spirit, scope or intent of the invention.

The resulting digital asset identification information is then stored in a digital asset profile corresponding to the system image. In turn, the digital asset profile is processed to separate the digital assets into two categories: digital assets that are available for sale or management by a vendor, such as a system manufacturer, and digital assets that are proprietary to a customer or are not available for sale or management by the vendor. The digital assets that are available from the vendor for licensing or management are then presented to a customer. The customer then selects which, if any, of the digital assets they wish to license from the vendor or have the vendor manage. All other digital assets are then stored “in the cloud” in a data repository dedicated to the customer.

The system image is then applied to a target system. In one embodiment, the digital assets licensed from the vendor and the customer-owned digital assets stored “in the cloud” are combined to generate the system image prior to its application to a target system. In another embodiment, the digital assets licensed from the vendor are used to generate the system image before it is applied to a target system. In this embodiment, the customer-owned digital assets stored “in the cloud” are subsequently downloaded and then applied to the system image that was previously applied to the target system. In yet another embodiment, the digital assets licensed from the vendor and the customer-owned digital assets stored “in the cloud” are combined to generate a system image that is likewise stored “in the cloud.” In this embodiment, the system image is downloaded and then subsequently applied to a target system. Those of skill in the art will recognize that many such embodiments are possible and the foregoing is not intended to limit the spirit, scope or intent of the invention.

Referring now to FIG. 2, a digital asset entitlement system 118 is implemented for managing the entitlement of a target system 254 to process a digital asset 246. In these and other embodiments, the digital asset entitlement system 118 may be implemented on one or more servers 210, which are connected to a network 252. In various embodiments, the network 252 may comprise a public network, such as the Internet, a physical private network, a virtual private network (VPN), or any combination thereof. As shown in FIG. 2, the digital asset entitlement system 118 comprises a user service and support module 120, a digital fulfillment module 122, and a system identification and security module 124. The digital asset entitlement system 118 likewise comprises a personalization module 126, an entitlement module 128, a sales integration module 130, a manufacturing integration module 132, a “custom” digital asset management module 134, and a mixed-licensing management module 136. Likewise, the digital asset entitlement system 118 is able to access a “licensable” digital assets data repository 212, an entitlement data repository 214, a system identifier (ID) data repository 216, and a “custom” digital assets repository 260, each of which may be implemented on one or more servers 210 connected to a network 252.

As used herein, a digital asset 246 refers to any digital asset such as a software application, a deliverable or performable service, music, video, software activation key, personalization instructions, files, etc. that are digitally deliverable either wholly or partially. As likewise used herein, a digital assets entitlement refers to the association of a predetermined digital asset 246 with a target 254 system. In various embodiments, an entitlement record contains digital assets entitlement data (e.g., license information, etc.) that allows the digital asset 246 to be respectively processed by the target 254 system, which is likewise identified by a corresponding unique target 256 system identifier. In these and other embodiments, the entitlement record is processed by the entitlement module 128 and stored in the entitlement data repository 214. As used herein, a target 254 system may comprise a personal computer, a laptop computer, or a tablet computer operable to establish an on-line session with the digital asset entitlement system 118 over a connection to network 252. The target 254 system may also comprise a personal digital assistant (PDA), a mobile telephone, or any other suitable device operable to store a unique target 254 system ID, respectively perform digital asset entitlement operations with a target 258 system personalization agent, and operable to establish a connection with network 252.

In various embodiments, the system purchaser 202 decides whether to purchase a custom-configured or pre-configured target 254 system. If the target 254 system is to be pre-configured, then it is selected for on-line purchase by the system purchaser 202 and its unique target system 256 identifier is determined. In one embodiment, the unique target 256 system identifier is stored in the BIOS of the pre-configured target 254 system. However, if the target 254 system is to be custom-configured, then it is custom-configured on-line by the system purchaser 202. Once manufactured by the system manufacturer 234, a unique target 256 system identifier is generated. In various embodiments, the manufacturing integration module 132 coordinates the custom configuration of the target 254 system with the system manufacturer 234. Likewise, the system identification and security module 124 coordinates the generation of the unique target 256 system identifier and its storage in the repository of system identifier data 216.

The system purchaser 202 then selects personalization options for the pre-configured or custom-configured system. In various embodiments, the personalization module 126 coordinates the selection of personalization options with the system manufacturer 234. As used herein, a system personalization option refers to any feature, capability, or function that may be applied to a target system. As an example, a personal computer desktop wallpaper or user interface options (e.g., a “classic” interface) are personalization options. A purchase transaction for the custom-configured or pre-configured system target 254 system and any personalization options is then completed. In various embodiments, the processing of the purchase transaction is performed by the sales integration module 230.

In various embodiments, the system purchaser 202 elects to have a predetermined system image comprising one or more digital assets be applied to the target system 254. In these and other embodiments, standard system image creation operations familiar to skilled practitioners of the art are performed, using a combination of complete system images and unique system image deltas to generate a system image for the target system 254.

The resulting system image is then processed to identify digital asset title identification information, which in turn is used populate a digital asset profile. In one embodiment, the digital asset title identification information is identified by processing the software package inventory from a Windows® Uninstall Registry tree. In another embodiment, the digital asset title identification information is identified by performing file recognition processes. In this and other embodiments, the file recognition processes further comprise performing filename and CRC comparison operations familiar to those of skill in the art. In yet another embodiment, the digital asset title identification information is identified by processing registry tree information to identify license, version and stock keeping unit (SKU) information. In still another embodiment, the digital asset title identification information is identified by processing license file information to identify license, version and stock keeping unit (SKU) information. Skilled practitioners of the art will realize that many such embodiments are possible and that the foregoing is not intended to limit the spirit, scope or intent of the invention.

The first digital asset title in the digital asset profile is then selected, and if it is identifiable, then a determination is made whether it is available for licensing from the system manufacturer 234. If so, then the digital asset title is marked as “available” for licensing from the system vendor in the digital asset profile. However, if the digital asset title is not identifiable, or is not available from the system manufacturer 234, then it is marked “custom” in the digital asset profile. The process is then repeated for each digital asset title in the digital asset profile.

Digital asset titles that are available for licensing from the system manufacturer 234 are subsequently presented to the system purchaser 202. Any digital asset titles that the system purchaser 202 elects to license from the system manufacturer 234 are marked as “license” in the digital asset profile. All other digital asset titles are marked as “custom” in the digital asset profile.

The digital assets 246 corresponding to digital asset titles marked as “custom” in the digital asset profile are then stored in the “custom” digital assets repository 260. In various embodiments, the “custom” digital assets repository 260 resides “in the cloud” on a storage device dedicated to the system purchaser 202. The digital assets 246 corresponding to digital asset titles marked as “license” in the digital asset profile are then licensed from the system manufacturer 234.

In various embodiments, a base system image is modified for a given target system 254. As an example, a corporation may have a standardized operating system (OS) version that is installed on every system. However, different departments may have different sets of digital assets 246 for their respective systems. In these various embodiments, the digital assets 246 may be a mixture of digital assets 246 that are licensed from the system manufacturer 234 and digital assets 246 that are either unavailable from the system manufacturer 234 or are proprietary to the corporation. Accordingly, it will be appreciated that it may be advantageous to replicate a base system image and then modify it appropriately for each target system.

In one embodiment, system image replication operations familiar to those of skill in the art are performed, using digital assets 246 licensed from the system manufacturer 234, one or more matching base system indexes, and “custom” digital assets 246 stored in the “custom” digital asset repository 260. If the system purchaser 202 has elected to license one or more digital assets 246 from the system manufacturer 234, then digital asset entitlement operations are performed. In this and other embodiments, the digital asset entitlement operations are performed by the digital asset entitlement system 118, which binds the digital assets 246, personalization options, and their respective digital assets entitlement data to the unique target 256 system identifier of the target 254 system. The resulting digital asset entitlements, including data associated with the digital assets (e.g., installation files, etc.) is then stored in the repository of entitlement data 214. The digital assets 246 are installed, and their corresponding licenses are applied to the system image, which in turn is then applied to the target system 254.

In one embodiment, the mixed-licensing management module 136, in combination with the “custom” digital asset management module 134, the entitlement module 130, the personalization module 126, the system identification and security module, and the digital fulfillment module 122, is used to apply the system image to the target system 254. In another embodiment, the system image is downloaded from the digital asset entitlement system 118 by the target 258 system personalization agent, which is then used to apply the system image to the target system. Skilled practitioners of the art will recognize that many such embodiments are possible and the foregoing is not intended to limit the spirit, scope or intent of the invention.

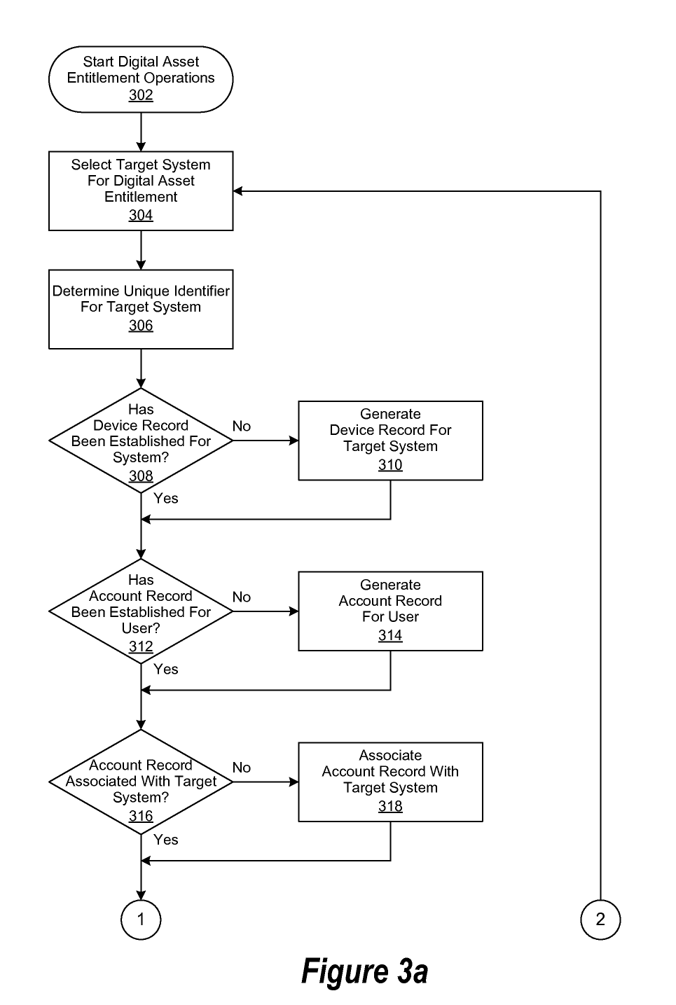

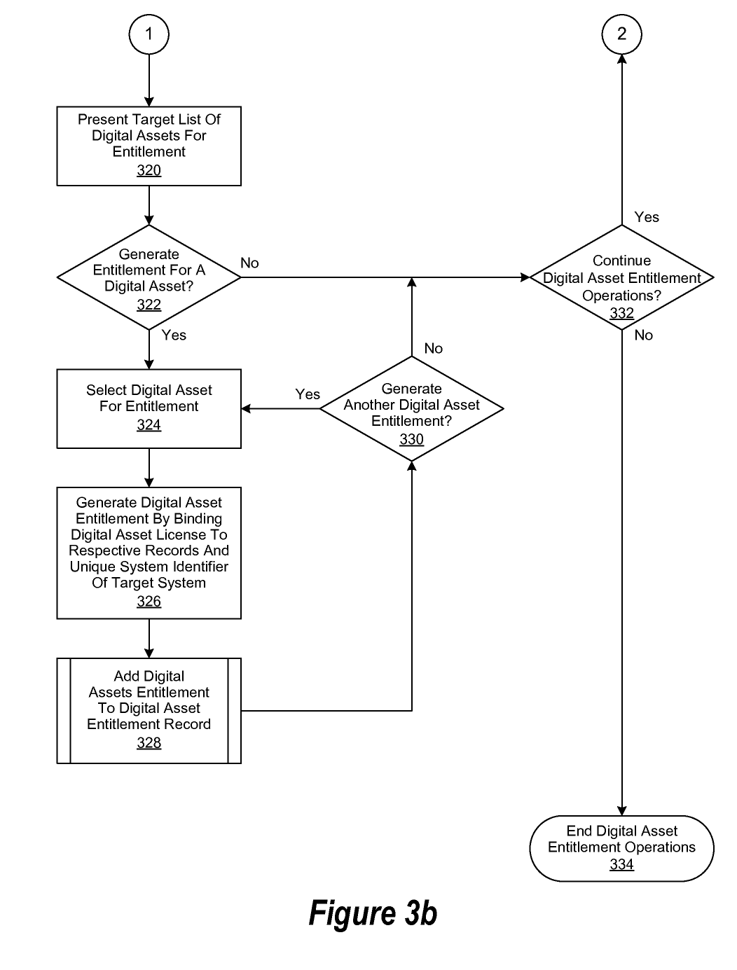

FIGS. 3a-b are a generalized flow chart of the performance of digital asset entitlement operations in an embodiment of the invention, In this embodiment, digital asset entitlement operations are started in step 302, followed by the selection of a target system in step 304 for digital assets entitlement. The unique system identifier of the target system, as described in greater detail herein, is determined in step 306, followed by a determination being made in step 308 whether a device record has been established for the target system. If not, then the device record is generated in step 310. As used herein, a device record refers to a data record containing data related to a system which will receive an entitlement to process associated digital assets. In various embodiments, the unique system identifier of the target system is stored in the device record. In various embodiments, other records may be associated with the device record to further describe the system, such as its model, type, make, internal identifiers, etc.

Once the device record has been generated, or if it is determined in step 308 that it has already been established, then a determination is made in step 312 whether an account record has been established for a user. If not, then the account record is generated for the user in step 314. As used herein, an account record refers to a data record containing data related to the association of multiple devices or systems to one or more entities. In various embodiments, the entity may be a single individual or a group of individuals. As an example, the entity may be a household with multiple PCs, a small business with several employees, a large corporation with many employees, etc. Other records may be attached to the account to further describe the account holder, payment information related to the account, etc. Accounts may further be broken down or organized into sub-accounts as needed, such as to describe departments within an enterprise). In various embodiments, a user may be associated with a single device or system or multiple devices or systems in the account record. Conversely, a group of users may be associated with a single device or system or multiple devices in the account record. Furthermore, groups of individual users may likewise be associated with groups of individual devices or systems. Those of skill in the art will recognize that many such associations are possible and the foregoing is not intended to limit the spirit, scope, or intent of the invention. Once the account record has been generated, or if it is determined in step 312 that it has already been established, then a determination is made in step 316 whether the account record is associated with the target system. If not, then the account record is associated with the target system in step 318.

Once the account record has been associated with the target system, or if it is determined in step 316 that it has already been associated, then a target list of digital assets is presented in step 320 for entitlement. A determination is then made in step 322 whether to generate an entitlement for a digital asset. If not, then a determination is made in step 332 whether to continue digital asset entitlement operations. If so, then the process is continued, proceeding with step 304. Otherwise digital asset entitlement operations are ended in step 334. However, if it is determined in step 322 to generate an entitlement for a digital asset, then a target digital asset is selected in step 324. A digital assets entitlement is then generated in step 326 by performing operations to associate the selected digital asset's corresponding license record with the aforementioned device record, account record, and other predetermined records. The resulting digital assets entitlement association is then added to the entitlement record in step 328. A determination is then made in step 330 whether to generate another digital assets entitlement. If so, the process is continued, proceeding with step 324. Otherwise, a determination is made in step 332 whether to continue digital asset entitlement operations. If so, then the process is continued, proceeding with step 304. Otherwise digital asset entitlement operations are ended in step 334.

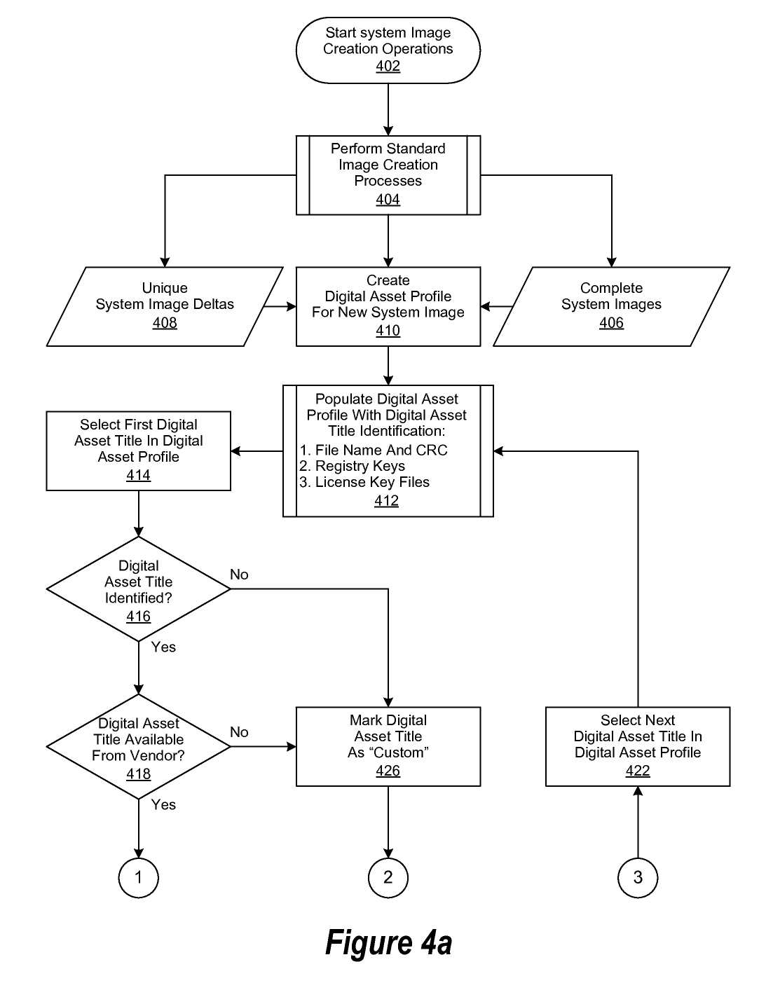

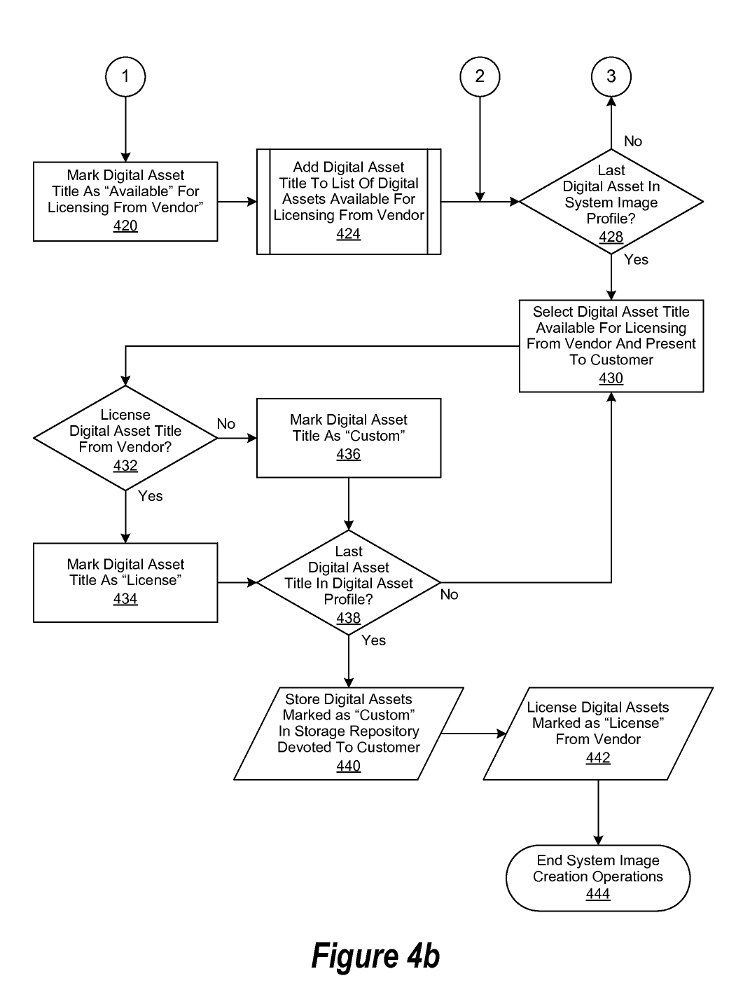

FIGS. 4a-b are a generalized flow chart of the performance of system image creation operations in accordance with an embodiment of the invention. In this embodiment, system image creation operations are begun in step 402, followed by the performance of standard system image creation operations familiar to skilled practitioners of the art in step 404. In this and other embodiments, complete system images and unique system image deltas, likewise familiar to those of skill in the art, are respectively provided in steps 408 and 410. Thereafter, and once standard system image creation processes are performed in step 404.

The resulting system image is then processed in step 412 to identify digital asset title identification information, which in turn is used populate the digital asset profile. The first digital asset title in the digital asset profile is then selected in step 414, followed by a determination being made in step 416 whether the selected digital asset title is identified. If so, then a determination is made in step 418 whether the digital asset title is available for licensing from the system vendor. If so, then the digital asset title is marked as “available” for licensing from the system vendor in the digital asset profile in step 420.

However, if it was determined in step 416 that the digital asset title was not identified, or in step 418 that the identified digital asset title was not available from the system vendor, then the digital asset title is marked in step 426 as “custom” in the digital asset profile. Thereafter, or once the digital asset title is added to a list of digital asset titles available for licensing from the system vendor in step 424, a determination is made in step 428 whether the digital asset title is the last digital asset title in the system image digital asset profile. If not, the next digital asset title in the digital asset profile is selected in step 422 and the process is continued, proceeding with step 412.

Otherwise, a digital asset title that is available for licensing from the system vendor is selected and presented to the customer in step 430. A determination is then made in step 432 whether the customer elects to license the digital asset title from the system vendor. If not, then the selected digital asset title is marked in step 436 as “custom” in the digital asset profile. Otherwise, the selected digital asset title is marked in step 434 as “license” in the digital asset profile. Thereafter, or if the selected digital asset title was marked as “custom” in the digital asset profile in step 424, then a determination is made in step 438 whether the selected digital asset title was the last digital asset title in the digital asset profile. If not, the process is continued, proceeding with step 430. Otherwise, the digital assets corresponding to digital asset titles marked as “custom” in the digital asset profile are stored in a storage repository dedicated to the customer in step 440. The digital assets corresponding to digital asset titles marked as “license” in the digital asset profile are then licensed from the system vendor in step 442. System image creation operations are then ended in step 444.

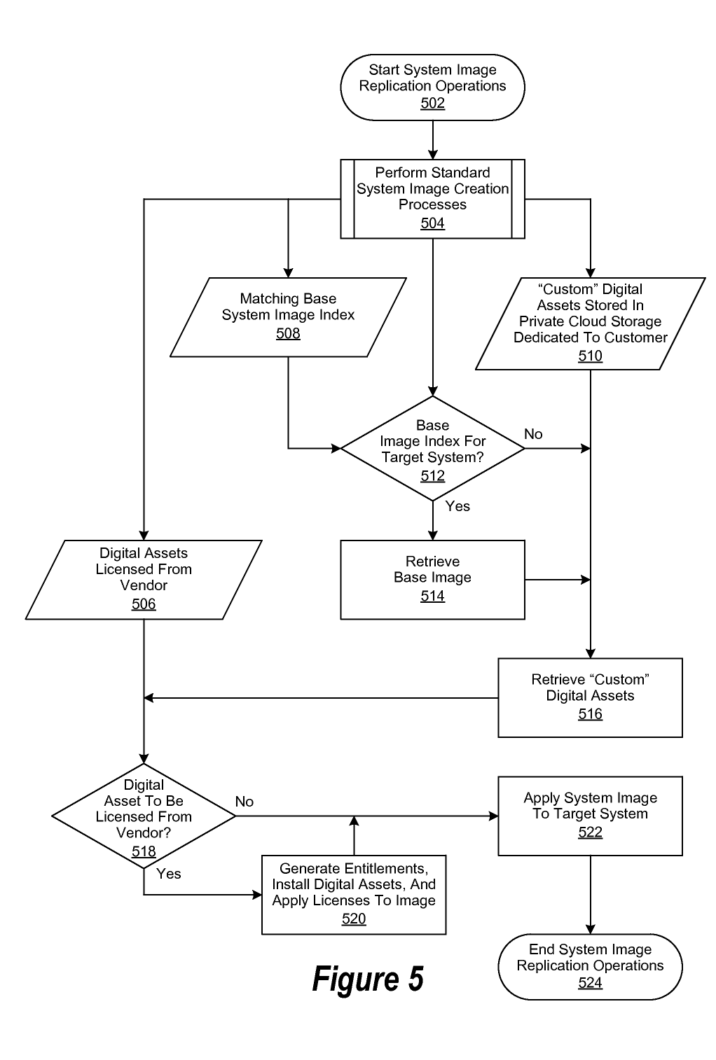

FIG. 5 is a generalized flow chart of the performance of system image replication operations in accordance with an embodiment of the invention. In this embodiment, system image replication operations are started in step 502, followed by the performance of standard system image creation operations, as described in greater detail herein, in step 504. In this and other embodiments, digital assets licensed from the system vendor, one or more matching base system indexes, and “custom” digital assets stored in a private cloud repository dedicated to the customer described in greater detail herein, are respectively provided in steps 506, 508 and 510.

Thereafter, and once standard system image creation processes are performed in step 504, a determination is made in step 512 whether a base image index exists for the target system. If so, it is retrieved in step 514. If not, or after it is retrieved in step 514 the “custom” digital assets are retrieved in step 516. Then, in step 518, a determination is made whether the customer has elected to license one or more digital assets from the system vendor. If so then digital asset entitlements are generated, as described in greater detail herein, the digital assets are installed, and their corresponding licenses are applied to the system image in step 520. Thereafter, or if it was determined in step 518 not to license a digital asset from the system vendor, then the system image is applied to the target system in step 522. System image replication operations are then ended in step 524.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for managing the licensing of digital assets, comprising:
processing a system image to generate identification data, the system image comprising digital assets corresponding to the identification data;
processing the identification data to generate a first set of license data corresponding to digital assets that are licensable by a vendor and a second set of license data corresponding to digital assets that are not licensable by the vendor;
providing the first set of license data to a user;
receiving selection data from the user, the selection data corresponding to a first subset and a second subset of the first set of license data, the first subset of license data corresponding to digital assets to be licensed from the vendor, the second subset of license data corresponding to digital assets not to be licensed from the vendor;
performing licensing operations to license the digital assets associated with the first subset of the first set of license data.

2. The method of claim 1, wherein the identification data comprises at least one of the set of:
a digital asset title;
a digital asset version identifier;
a digital asset language identifier;
a Stock Keeping Unit (SKU); and
a digital asset licensing method.

3. The method of claim 1, wherein:
a license attribute is generated, the license attribute assigned to the first subset of license data; and
a non-license attribute is generated, the non-license attribute assigned to the first set of license data and the second subset of license data.

4. The method of claim 1, wherein the digital assets corresponding to the second set of license data and the second subset of license data are stored in a repository of non-licensed digital assets.

5. The method of claim 1, wherein the system image is applied to a target system.

6. The method of claim 5, wherein:
a license attribute is generated and the license attribute is assigned to the first subset of license data; and
a non-license attribute is generated and the non-license attribute is assigned to the first set of license data and the second subset of license data.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
processing a system image to generate identification data, the system image comprising digital assets corresponding to the identification data;
processing the identification data to generate a first set of license data corresponding to digital assets that are licensable by a vendor and a second set of license data corresponding to digital assets that are not licensable by the vendor;
providing the first set of license data to a user;
receiving selection data from the user, the selection data corresponding to a first subset and a second subset of the first set of license data, the first subset of license data corresponding to digital assets to be licensed from the vendor, the second subset of license data corresponding to digital assets not to be licensed from the vendor;
performing licensing operations to license the digital assets associated with the first subset of the first set of license data.

8. The system of claim 7, wherein the identification data comprises at least one of the set of:
a digital asset title;
a digital asset version identifier;
a digital asset language identifier;
a Stock Keeping Unit (SKU); and
a digital asset licensing method.

9. The system of claim 7, wherein:
a license attribute is generated and the license attribute is assigned to the first subset of license data; and
a non-license attribute is generated and the non-license attribute is assigned to the first set of license data and the second subset of license data.

10. The system of claim 7, wherein the digital assets corresponding to the second set of license data and the second subset of license data are stored in a repository of non-licensed digital assets.

11. The system of claim 7, wherein the system image is applied to a target system.

12. The system of claim 11, wherein:
the system image is initially applied using only digital assets corresponding to the first subset of license data; and
digital assets corresponding to the second set of license data and the second subset of the license data are subsequently applied to the system image.

13. A non-transitory, computer-readable storage medium embodying computer program code, the computer program code comprising computer executable instructions configured for:
processing a system image to generate identification data, the system image comprising digital assets corresponding to the identification data;
processing the identification data to generate a first set of license data corresponding to digital assets that are licensable by a vendor and a second set of license data corresponding to digital assets that are not licensable by the vendor;
providing the first set of license data to a user;
receiving selection data from the user, the selection data corresponding to a first subset and a second subset of the first set of license data, the first subset of license data corresponding to digital assets to be licensed from the vendor, the second subset of license data corresponding to digital assets not to be licensed from the vendor;
performing licensing operations to license the digital assets associated with the first subset of the first set of license data.

14. The non-transitory, computer-readable storage medium of claim 13, wherein the identification data comprises at least one of the set of:
a digital asset title;
a digital asset version identifier;
a digital asset language identifier;
a Stock Keeping Unit (SKU); and
a digital asset licensing method.

15. The non-transitory, computer-readable storage medium of claim 13, wherein:
a license attribute is generated and the license attribute is assigned to the first subset of license data; and
a non-license attribute is generated and the non-license attribute is assigned to the first set of license data and the second subset of license data.

16. The non-transitory, computer-readable storage medium of claim 13, wherein the digital assets corresponding to the second set of license data and the second subset of license data are stored in a repository of non-licensed digital assets.

17. The non-transitory, computer-readable storage medium of claim 13, wherein the system image is applied to a target system.

18. The non-transitory, computer-readable storage medium of claim 17, wherein:
the system image is initially applied using only digital assets corresponding to the first subset of license data; and
digital assets corresponding to the second set of license data and the second subset of the license data are subsequently applied to the system image.
